(19) United States
(12) Patent Application Publication
(10) Pub. No.: US 2024/0418930 A1
(43) Pub. Date: Dec. 19, 2024

(54) OPTICAL FIBER AND OPTICAL CABLE

(71) Applicant: SUMITOMO ELECTRIC INDUSTRIES, LTD., Osaka (JP)

(72) Inventors: Kazuyuki SOHMA, Osaka (JP); Takahiro NOMURA, Osaka (JP); Keisei MORITA, Osaka (JP); Satoshi OGAWA, Osaka (JP)

(21) Appl. No.: 18/814,864

(22) Filed: Aug. 26, 2024

(30) Foreign Application Priority Data
Jul. 26, 2024 (JP) 2024-120905

(51) Int. Cl. G02B 6/02

(52) U.S. Cl. CPC G02B 6/02395; G02B 6/02009

(57) ABSTRACT

A primary resin layer has a thickness of 4 μm or more and Young's modulus of 0.3 MPa or less. A secondary resin layer has a radius of 85 μm or less, a thickness of 7.5 μm or more, and Young's modulus of 1250 MPa or more. A MFD of an optical fiber at a wavelength of 1310 nm is greater than 8.2 μm, and the MFD at a wavelength of 1550 nm is 9.40 μm or more and 10.5 μm or less. Relative ratio of D/H², which indicates the relationship between lateral rigidity D and bending rigidity H of the optical fiber, to a reference 200 μm single fiber is 540 or less. A cross-sectional area of the coating layer that excludes the primary resin layer is 4400 μm² or more and 12000 μm² or less. The optical fiber has a zero-dispersion slope of 0.092 ps/nm²/km or less.

The present application claims priority based on Japanese Patent Application No. 2024-120905, filed on Jul. 26, 2024, the entire contents of which are incorporated herein by reference.

### TECHNICAL FIELD

The present disclosure relates to an optical fiber and an optical cable.

### BACKGROUND

The increase in communication traffic has made constructing an economical optical network important. In this context, from the perspective of reducing transportation and installation costs or the like there are expectations for optical cables to become smaller in diameter and higher in density. Along with this, there is also a demand for the optical fibers themselves to become smaller in diameter. Examples of small-diameter optical fibers are disclosed in U.S. Pat. Nos. 11,874,494, 11,181,687, 11,719,878, and 11,709,313. However, the reduction in diameter leads to a challenge of increased micro-bending loss occurring during cabling. Thus, it is necessary to consider the structure based on an analytical formula that can systematically estimate the impact of the optical fiber structure.

A non-patent literature (F. Cocchini, “The Lateral Rigidity of Double-Coated Optical Fibers”, JOURNAL OF LIGHTWAVE TECHNOLOGY, Vol. 13, No. 8, August 1995) discloses that the micro-bending resistance characteristics of an optical fiber are associated with the lateral rigidity D and the bending rigidity H of the optical fiber, which can be calculated using an approximation formula. WO 2018/025896 describes that the approximation formula in the literature mentioned above has been extended to more accurately reflect reality.

### SUMMARY

An optical fiber according to one embodiment of the present disclosure includes a glass fiber provided with a core and a cladding surrounding the core, and a coating layer surrounding the glass fiber. The core is formed from silica glass doped with at least one of germanium, titanium, chlorine, fluorine, and alkali metals. The cladding includes an inner cladding that is in contact with the core and surrounds the core, an outer cladding surrounding the inner cladding, and a trench placed between the inner cladding and the outer cladding in the radial direction. The coating layer includes a primary resin layer surrounding the cladding and a secondary resin layer surrounding the primary resin layer. The core has a radius of 3.6 μm or more and 5.4 μm or less, and the relative refractive index difference of the core with respect to the refractive index of the cladding is greater than the refractive index of the cladding by 0.32% or more and 0.40% or less. The volume of the trench is less than −30% μm². The radius of the cladding is 63 μm or less. The thickness of the primary resin layer is 4 μm or more, and Young's modulus of the primary resin layer is 0.3 MPa or less. The radius of the secondary resin layer is 85 μm or less, the thickness of the secondary resin layer is 7.5 μm or more, and Young's modulus of the secondary resin layer is 1250 MPa or more. The effective cross-sectional area of the optical fiber at a wavelength of 1550 nm is 100 μm² or less. The mode field diameter of the optical fiber at a wavelength of 1310 nm is greater than 8.2 μm. The mode field diameter of the optical fiber at a wavelength of 1550 nm is 9.40 μm or more and 10.5 μm or less. The cable cutoff wavelength of the optical fiber is less than 1420 nm. The bending loss of the optical fiber at a wavelength of 1550 nm upon being wound with a bending diameter of 10 mm is 1 dB/turn or less. The relative ratio of D/H², which indicates the relationship between a lateral rigidity D and a bending rigidity H of the optical fiber, to D/H² of a reference 200 μm single fiber is 540 or less. The cross-sectional area of the coating layer that excludes the primary resin layer is 4400 μm² or more and 12000 μm² or less. The absolute difference between the refractive index of the cladding and the refractive index of the coating layer is greater than 0.01. The optical fiber has a zero-dispersion slope of 0.092 ps/nm²/km or less.

### BRIEF DESCRIPTION OF THE DRAWINGS

FIG. 1 is a cross-sectional view of an optical fiber according to one embodiment, perpendicular to the fiber axis;

FIG. 2 is a cross-sectional view illustrating a modification of the optical fiber illustrated in FIG. 1; and

FIG. 3 is a cross-sectional view of an optical cable according to one embodiment, perpendicular to the central axis.

### DETAILED DESCRIPTION

### Problem to be Solved by Present Disclosure

As the diameter of optical fibers decreases, micro-bending loss may increase. Thus, it is desirable to reduce micro-bending loss even the case where the optical fiber becomes smaller in diameter.

### Effects of Present Disclosure

According to the present disclosure, it is possible to reduce micro-bending loss in a small-diameter optical fiber and an optical cable including the small-diameter optical fiber.

### DESCRIPTION OF ASPECTS OF PRESENT DISCLOSURE

Embodiments of the present disclosure are now listed and described.
[1] An optical fiber according to one embodiment of the present disclosure includes a glass fiber provided with a core and a cladding surrounding the core, and a coating layer surrounding the glass fiber. The core is formed from silica glass doped with at least one of germanium, titanium, chlorine, fluorine, and alkali metals. The cladding includes an inner cladding that is in contact with the core and surrounds the core, an outer cladding surrounding the inner cladding, and a trench placed between the inner cladding and the outer cladding in the radial direction. The coating layer includes a primary resin layer surrounding the cladding and a secondary resin layer surrounding the primary resin layer. The core has a radius of 3.6 μm or more and 5.4 μm or less, and the relative refractive index difference of the core with respect to the refractive index of the cladding is greater than the refractive index of the cladding by 0.32% or more and 0.40% or less. The volume of the trench is less than −30% μm². The radius of the cladding is 63 μm or less. The thickness of the primary resin layer is 4 μm or more, and Young's modulus of the primary resin layer is 0.3 MPa or less. The radius of the secondary resin layer is 85 μm or less, the thickness of the secondary resin layer is 7.5 μm or more, and Young's modulus of the secondary resin layer is 1250 MPa or more. The effective cross-sectional area of the optical fiber at a wavelength of 1550 nm is 100 μm² or less. The mode field diameter of the optical fiber at a wavelength of 1310 nm is greater than 8.2 μm. The mode field diameter of the optical fiber at a wavelength of 1550 nm is 9.40 μm or more and 10.5 μm or less. The cable cutoff wavelength of the optical fiber is less than 1420 nm. The bending loss of the optical fiber at a wavelength of 1550 nm upon being wound with a bending diameter of 10 mm is 1 dB/turn or less. The relative ratio of D/H², which indicates the relationship between a lateral rigidity D and a bending rigidity H of the optical fiber, to D/H² of a reference 200 μm single fiber is 540 or less. The cross-sectional area of the coating layer that excludes the primary resin layer is 4400 μm² or more and 12000 μm² or less. The absolute difference between the refractive index of the cladding and the refractive index of the coating layer is greater than 0.01. The optical fiber has a zero-dispersion slope of 0.092 ps/nm²/km or less.

In this optical fiber, the radius of the cladding is 63 μm or less, and the radius of the secondary resin layer is 85 μm or less, allowing for the provision of a small-diameter optical fiber. Additionally, the relationship between the lateral rigidity D and the bending rigidity H of the optical fiber, indicated as D/H², is associated with the micro-bending loss, and can be expressed as the micro-bending loss Δα_{micro}=A×D/H². In this equation, A is a constant that depends on the refractive index structure of the optical fiber. Herein, the relative ratio to D/H² compared to a reference 200 μm single fiber is set to be 540 or less. By using an optical fiber with such a rigidity ratio, it is possible to reduce the micro-bending loss. This also reduces the cable loss when each optical fiber is incorporated into a cable. If such a rigidity ratio is greater than 540, the transmission loss increases due to slight lateral pressure, making it difficult to improve the core density when cabled or corded. Herein, the calculation conditions for D/H² of the reference 200 μm single fiber are as follows as an example.
The radius of the glass fiber is 62.5 μm.
The radius of the primary resin layer is 85 μm.
The radius of the secondary resin layer is 96.5 μm.
Young's modulus of the glass fiber is 72500 [MPa].
Young's modulus of the primary resin layer is 0.4 [MPa].
Young's modulus of the secondary resin layer is 1500 [MPa].
[2] In the optical fiber of the item [1] mentioned above, the volume of the trench may be −380%·μm² or more and −126%·μm² or less. In this case, the mode field diameter at 1310 nm can be expanded to, for example, 8.7 μm or more while maintaining low micro-bending loss.
[3] In the optical fiber of the item [1] or [2] mentioned above, given that the radius of the glass fiber is R0 [m], Young's modulus of the glass fiber is E0 [N/m²], the radius of the primary resin layer is R1 [m], Young's modulus of the primary resin layer is E1 [N/m²], the radius of the secondary resin layer is R2 [m], and Young's modulus of the secondary resin layer is E2 [N/m²], then, the relationship between the lateral rigidity D [N/m²] indicated in Formula (1) and the bending rigidity H [N/m²] indicated in Formula (2) of the optical fiber satisfies Formula (3), and the coating eccentricity may be 8 μm or less.

$$D = \{ \frac{c 1}{{( 1 - \frac{R 0}{R 2} )}^{c 2}} + c 3 \} \{ ( E 2 - E 1 ) {10}^{{\sum }_{i , j , k} {{c}_{ijk} ( {log}_{10} \frac{R 2 - R 1}{R 2 - R 0} )}^{i} {( {log}_{10} \frac{E 1}{E 2} )}^{j} {( {log}_{10} \frac{R 0}{R 2} )}^{k}} + E 1 \} \qquad ( 1 )$$

$$H ∝ π R {0}^{4} E 0 + π ( R {2}^{4} - R {1}^{4} ) E 2 \qquad ( 2 )$$

$$D / {H}^{2} [ {N}^{- 1} \cdot {m}^{- 6} ] ≦ 6.6 \times {10}^{18} [ {N}^{- 1} \cdot {m}^{- 6} ] \qquad ( 3 )$$

Here, c1=0.209367, c2=1.206659, and c3=0.401169, and cᵢⱼₖ is as follows.

$$\begin{matrix}{c}_{000} = - 0.611554 \\ {c}_{100} = 3.615414 \\ {c}_{010} = 0.253128 \\ {c}_{001} = - 7.130445 \\ {c}_{200} = 0.787599 \\ {c}_{110} = 0.329243 \\ {c}_{101} = 2.32008 \\ {c}_{020} = - 0.062024 \\ {c}_{011} = - 0.985974 \\ {c}_{002} = - 8.696048\end{matrix}$$

The approximation formula disclosed in WO 2018/025896 is calculated based on numerical analysis that limits the diameter of the glass fiber (glass diameter) to 125 μm. For this reason, it has been found that when applied to optical fibers with different glass diameters, the offset between the calculated values and the actual measured values of micro-bending loss can be significant. In other words, the optical fiber disclosed in WO 2018/025896 is sometimes unlikely to effectively suppress micro-bending loss. In contrast, in the optical fiber of the item [3] mentioned above, the lateral rigidity D and bending rigidity H satisfy Formula (3), thereby ensuring reliable suppression of micro-bending loss. In addition, due to the low coating eccentricity, the offset between the calculated value of micro-bending loss and the actual measured value is less likely to become large. Thus, it is possible to more reliably reduce micro-bending loss.
[4] In any of the optical fibers of the items [1] to [3] mentioned above, the coating layer may further include a colored layer surrounding the secondary resin layer. The cross-sectional area of the portion of the coating layer constituted of the secondary resin layer and the colored layer may be 4400 μm² or more and 12000 μm² or less. The cross-sectional area of the portion of the coating layer of 4400 μm² or more makes it easier to reduce the influence of external damage on the optical fiber. On the other hand, the cross-sectional area of the portion of the coating layer of 12000 μm² or less makes it possible to reduce the cracking of the coating due to external damage to the optical fiber.
[5] In any of the optical fibers of the items [1] to [4] mentioned above, the radius of the secondary resin layer may be 81 μm or less. In this case, the optical fiber can be made with a reduced diameter and increased density.
[6] In any of the optical fibers of the items [1] to [4] mentioned above, the radius of the secondary resin layer may be 51 μm or less. In this case, the optical fiber can be made with a reduced diameter and further increased density.
[7] In any of the optical fibers of the items [1] to [6] mentioned above, the median breaking stress of the optical fiber may be 1.5 GPa or more when a tensile test is performed in a tensile tester having a first mandrel and a second mandrel, with sandpaper having an average particle size of 15 μm or more and 25 μm or less wrapped around the first mandrel. In this case, it is possible to improve the durability and resistance to external damage in the small-diameter optical fiber.
[8] In any of the optical fibers of the items [1] to [7] mentioned above, the bending loss of the optical fiber at a wavelength of 1625 nm when wound with a bending diameter of 10 mm may be 3 dB/turn or less. In this case, the transmission loss in the small-diameter optical fiber can be reduced.
[9] An optical cable according to an embodiment of the present disclosure includes a plurality of the optical fibers according to any of the items [1] to [8] mentioned above. In this case, the optical cable can have reduced micro-bending loss. In addition, using a small-diameter optical fiber allows for a higher-density cable.

### DETAILS OF EMBODIMENT OF PRESENT DISCLOSURE

Specific examples of an optical fiber and an optical cable according to the present embodiment will be described with reference to the drawings as necessary. The present invention is not limited to these examples, and is defined by the claims, and it is intended to include all modifications within the meaning and scope equivalent to the claims. In the description of the drawings, the same elements are denoted by the same reference numerals, and duplicated descriptions are omitted.

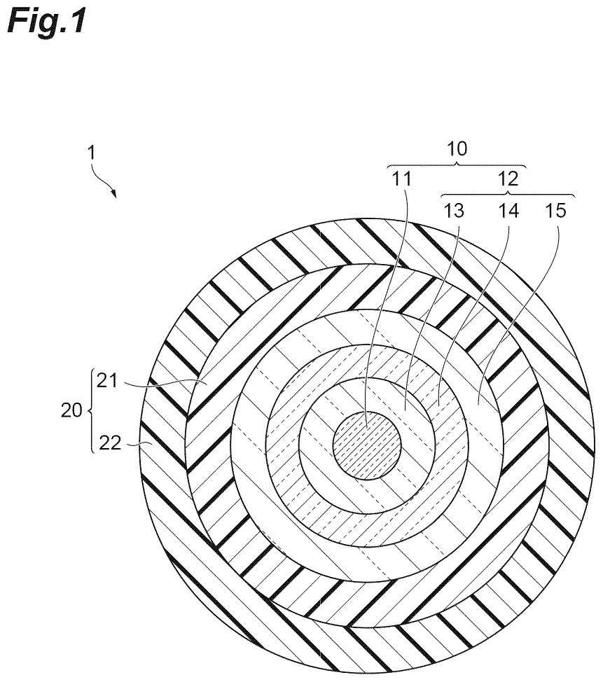

FIG. 1 is a cross-sectional view of an optical fiber according to an embodiment, perpendicular to the fiber axis. As illustrated in FIG. 1, an optical fiber 1 includes a glass fiber 10 and a coating resin 20 (coating layer).

The glass fiber 10 is formed from silica glass (SiO₂). The glass fiber 10 includes a core 11 and a cladding 12. The core 11 extends along the fiber axis of the optical fiber 1. The radius of the core 11 is 3.6 μm or more and 5.6 μm or less. The refractive index of the core 11 is higher than the refractive index of the cladding 12. The relative refractive index difference of the core 11 with respect to the cladding 12 is, for example, 0.32% or more and 0.40% or less. In the present embodiment, micro-bending loss is decreased, so the relative refractive index difference of the core 11 can be reduced. The core 11 is formed from silica glass to which at least one of germanium, titanium, chlorine, fluorine, and alkali metal elements is added. The alkali metal element added to the core 11 is, for example, sodium (Na), potassium (K), lithium (Li), rubidium (Rb), or cesium (Cs).

The cladding 12 surrounds the core 11 and covers the outer peripheral surface of the core 11. The cladding 12 is formed, for example, from pure silica glass. The cladding 12 has an inner cladding 13, a trench 14, and an outer cladding 15. The inner cladding 13 is in contact with the core 11 and surrounds the core 11. The outer cladding 15 surrounds the inner cladding 13. The trench 14 is placed between the inner cladding 13 and the outer cladding 15 in the radial direction. The radius of the inner cladding 13 is, for example, 7 μm or more and 20 μm or less. The radius of the trench 14 is, for example, 11 μm or more and 34 μm or less. The radius of the outer cladding 15 is, for example, 20 μm or more and 63 μm or less.

Young's modulus of the glass fiber 10 including the core 11 and the cladding 12 is, for example, 70 GPa or more and 80 GPa or less. The volume of the trench 14 may be, for example, −380%·μm² or more and −126%·μm² or less. The trench 14 is provided in the cladding 12 in this manner, so it is possible to reduce micro-bending loss in the optical fiber 1.

The coating resin 20 is formed from an ultraviolet-curable resin. The coating resin 20 includes a primary resin layer 21 surrounding the cladding 12 (the outer cladding 15) and a secondary resin layer 22 surrounding the primary resin layer 21. The primary resin layer 21 surrounds the glass fiber 10 and covers the outer peripheral surface of the glass fiber 10 (the outer cladding 15 of the cladding 12). The primary resin layer 21 is provided in contact with the cladding 12. The radius of the primary resin layer 21 is, for example, 40 μm or more and 70 μm or less. The thickness of the primary resin layer 21 is, for example, 4 μm or more and 30 μm or less, and may be 25 μm or less.

Young's modulus of the primary resin layer 21 is, for example, 0.05 MPa or more and 0.3 MPa or less. To reduce the micro-bending loss, it is preferable for Young's modulus of the primary resin layer 21 to be low. If Young's modulus of the primary resin layer 21 exceeds 0.3 MPa, the micro-bending loss fails to be sufficiently reduced. On the other hand, if Young's modulus of the primary resin layer 21 is too low, there is a possibility that the coating resin 20 including the primary resin layer 21 and the secondary resin layer 22 may be damaged. Setting Young's modulus of the primary resin layer 21 to 0.05 MPa or more prevents damage to the coating resin 20.

The primary resin layer 21 may employ, for example, a polyether-based or polyester-based urethane acrylate. The primary resin layer 21 may also contain a reactive diluent monomer and a photoinitiator as needed. Young's modulus of the primary resin layer 21 is adjustable, for example, based on the molecular weight of the polyether portion of the ultraviolet-curable resin and the type of diluent monomer used.

The primary resin layer 21 includes, for example, a photoinitiator-containing phosphorus in an amount of 0.3% by mass or more and 2.0% by mass or less. The primary resin layer 21 includes, for example, polypropylene glycol with a mass average molecular weight of 1000 or more and 5000 or less. As a result, in the optical fiber 1 having the primary resin layer 21 with a relatively low Young's modulus, even if the optical fiber 1 is subjected to an external force during processes such as rewinding or unitization, delamination at the interface between the glass fiber 10 and the primary resin layer 21 or destruction of the resin coating is less likely to occur.

The secondary resin layer 22 surrounds the primary resin layer 21 and covers the outer peripheral surface of the primary resin layer 21. The radius of the secondary resin layer 22 is, for example, 50 μm or more and 85 μm or less. The radius of the secondary resin layer 22 may be 81 μm or less, or may be 51 μm or less. The diameter of the secondary resin layer 22 corresponds to the diameter (coating diameter) of the coating resin 20 when no additional colored layer (ink layer) is provided on the outer periphery of the secondary resin layer 22. The thickness of the secondary resin layer 22 is, for example, 7.5 μm or more and 25 μm or less, and may be 10 μm or more. Young's modulus of the secondary resin layer 22 is, for example, 1250 MPa or more and 3000 MPa or less.

The secondary resin layer 22 employs, for example, polyether-based or polyester-based urethane acrylate. The secondary resin layer 22 may also contain a reactive diluent monomer and a photoinitiator as necessary. Young's modulus of the secondary resin layer 22 can be adjusted, for example, based on the molecular weight of the polyether portion of the ultraviolet-curable resin and the type of diluent monomer.

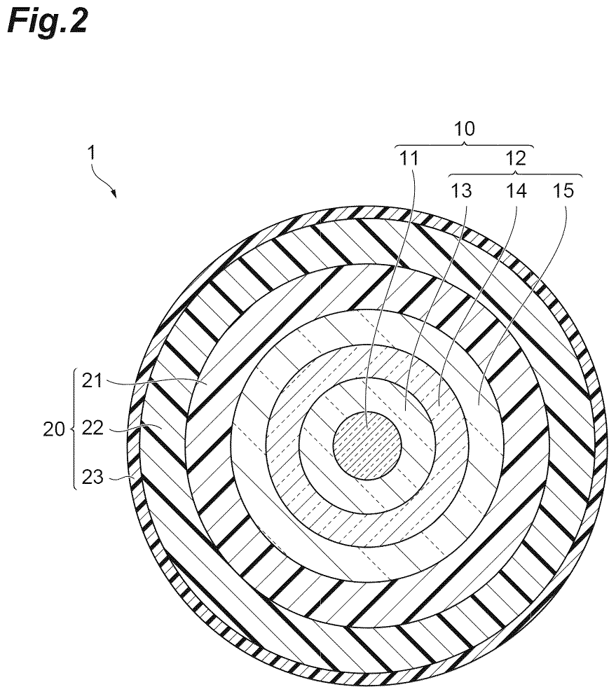

As illustrated in FIG. 2, the coating resin 20 may further include a colored layer 23 surrounding the secondary resin layer 22 on the outer periphery of the secondary resin layer 22. The colored layer 23 is a layer formed from colored ink for identification purposes. By applying various colors to each optical fiber 1, it is possible to identify the optical fiber 1. The thickness of the colored layer 23 is, for example, 2 μm or more and 5 μm or less. In addition, one or more marks are acceptable to be provided as a set between the colored layer 23 and the secondary resin layer 22, and these may be provided periodically in the length direction.

In the optical fiber 1, the total cross-sectional area of the secondary resin layer 22 and the colored layer 23 (if formed) of the coating resin 20 is, for example, 4400 μm² or more and 12000 μm² or less. The term “total cross-sectional area of the secondary resin layer 22 and the colored layer 23 (if formed)” herein corresponds to the cross-sectional area of the coating resin 20 that excludes the primary resin layer 21. If the colored layer 23 is not formed, the total cross-sectional area of the secondary resin layer 22 of the coating resin 20 is, for example, 4400 μm² or more and 12000 μm² or less. In addition, the ratio of the thickness of the primary resin layer 21 to the total thickness of the secondary resin layer 22 and the colored layer 23 (if formed) is, for example, 0.25 or more and 1.50 or less.

The effective cross-sectional area of the optical fiber 1 at a wavelength of 1550 nm is, for example, 100 μm² or less. The mode field diameter (MFD) of the optical fiber 1 at a wavelength of 1310 nm is, for example, greater than 8.2 μm and equal to or less than 9.50 μm. The mode field diameter (MFD) of the optical fiber 1 at a wavelength of 1550 nm is, for example, 9.40 μm or more and 10.5 μm or less, and may be 10 μm or more. The mode field diameter (MFD) of the optical fiber 1 at a wavelength of 1625 nm is, for example, 9.70 μm or more and 10.90 μm or less. The cable cutoff wavelength of the optical fiber 1 is, for example, less than 1420 nm, and may also be less than 1310 nm.

In the optical fiber 1, the bending loss of the optical fiber 1 at a wavelength of 1550 nm when wound with a bending diameter of 10 mm is, for example, 1 dB/turn or less. In the optical fiber 1, the bending loss of the optical fiber 1 at a wavelength of 1550 nm when wound with a bending diameter of 15 mm is, for example, 0.3 dB/turn or less. In the optical fiber 1, the bending loss of the optical fiber 1 at a wavelength of 1550 nm when wound with a bending diameter of 20 mm is, for example, 0.05 dB/turn or less. In the optical fiber 1, the bending loss of the optical fiber 1 at a wavelength of 1550 nm when wound with a bending diameter of 30 mm is, for example, 0.01 dB/turn or less. In the optical fiber 1, the bending loss of the optical fiber 1 at a wavelength of 1625 nm when wound with a bending diameter of 10 mm is, for example, 5.0 dB/turn or less, and may also be 3 dB/turn or less.

In the optical fiber 1, the absolute difference between the refractive index of the cladding 12 and the refractive index of the coating resin 20 including the primary resin layer 21 and the secondary resin layer 22 is greater than 0.01. The optical fiber 1 has a zero-dispersion slope of 0.092 ps/nm²/km or less.

The coating eccentricity of the optical fiber 1 is, for example, 8 μm or less. Herein, the coating eccentricity is defined as the distance from the central axis of the coating resin 20 (secondary resin layer 22) based on the outer periphery to the central axis of the glass fiber 10. In a cross-section perpendicular to the fiber axis, the offset between the center of the outer perimeter of the coating resin 20 and the center of the glass fiber 10 is the coating eccentricity. The coating eccentricity may be 6 μm or less. The coating eccentricity is likely to vary in the longitudinal direction of the optical fiber 1, and thus it is desirable to measure it at multiple points in the longitudinal direction of the optical fiber 1. Preferably, the average of the values measured at 500 or more points at intervals of 1 mm to 100 mm may be used as the coating eccentricity.

As described above, when the approximation formula disclosed in WO 2018/025896 is applied to an optical fiber having a glass diameter other than 125 μm, there may be a large discrepancy between the calculated value of the micro-bending loss and the actual measured value. It has been found that the micro-bending loss calculated by the approximation formula disclosed in WO 2018/025896 is lower than the actual value, especially in a small-diameter optical fiber. Thus, the present inventors have derived an approximation formula that extends to a range in which the glass diameter is smaller than 125 μm or the coating diameter is smaller than 160 μm, and specified an optical fiber 1 that can reliably suppress micro-bending loss even in the case of a small diameter, as described below.

In other words, given that the radius of the glass fiber 10 is R0 [m], Young's modulus of the glass fiber 10 is E0 [N/m²], the radius of the primary resin layer 21 is R1 [m], Young's modulus of the primary resin layer 21 is E1 [N/m²], the radius of the secondary resin layer 22 is R2 [m], and Young's modulus of the secondary resin layer 22 is E2 [N/m²], then, the relationship between the lateral rigidity (lateral elastic modulus) D [N/m²] of the optical fiber, indicated in Formula (1) and the bending rigidity (bending elastic modulus) H [Nm²] of the optical fiber, indicated in Formula (2), satisfies Formula (3).

$$D = \{ \frac{c 1}{{( 1 - \frac{R 0}{R 2} )}^{c 2}} + c 3 \} \{ ( E 2 - E 1 ) {10}^{{\sum }_{i , j , k} {{c}_{ijk} ( {log}_{10} \frac{R 2 - R 1}{R 2 - R 0} )}^{i} {( {log}_{10} \frac{E 1}{E 2} )}^{j} {( {log}_{10} \frac{R 0}{R 2} )}^{k}} + E 1 \} \qquad ( 1 )$$

$$H ∝ π R {0}^{4} E 0 + π ( R {2}^{4} - R {1}^{4} ) E 2 \qquad ( 2 )$$

$$D / {H}^{2} [ {N}^{- 1} \cdot {m}^{- 6} ] ≦ 6.6 \times {10}^{18} [ {N}^{- 1} \cdot {m}^{- 6} ] \qquad ( 3 )$$

Here, c1=0.209367, c2=1.206659, and c3=0.401169, and cᵢⱼₖ is as follows.

$$\begin{matrix}{c}_{000} = - 0.611554 \\ {c}_{100} = 3.615414 \\ {c}_{010} = 0.253128 \\ {c}_{001} = - 7.130445 \\ {c}_{200} = 0.787599 \\ {c}_{110} = 0.329243 \\ {c}_{101} = 2.32008 \\ {c}_{020} = - 0.062024 \\ {c}_{011} = - 0.985974 \\ {c}_{002} = - 8.696048\end{matrix}$$

Formula (2) is the equation used for the bending rigidity H indicated in the non-patent literature (F. Cocchini, “The Lateral Rigidity of Double-Coated Optical Fibers”, JOURNAL OF LIGHTWAVE TECHNOLOGY, Vol. 13, No. 8, August 1995). The derivation methods of Formulas (1) and (3) are described below.

In general, the micro-bending loss α of an optical fiber is expressed using the lateral rigidity D, the bending rigidity H, and a constant A due to the optical properties of the optical fiber in the approximation formula of Formula (4).

$$α \sim A \times ( \frac{D}{{H}^{2}} ) \qquad ( 4 )$$

The micro-bending loss α of a small-diameter optical fiber is desirably 5.0 dB/km or less, preferably 3.0 dB/km or less, and more preferably 1.0 dB/km or less. Thus, the constant A in Formula (4) is calculated from the actual measured value of the micro-bending loss α, and the results of D/H² that satisfies the above value are indicated in Table 1. From the results indicated in Table 1, Formula (3) was obtained as the conditional formula for D/H² that suppresses the micro-bending loss α to 5.0 dB/km or less.

TABLE 1

| D/H² | 6.6 × 10¹⁸ | 3.9 × 10¹⁸ | 1.3 × 10¹⁸ |
|---|---|---|---|
| A | 7.6 × 10⁻¹⁹ | 7.6 × 10⁻¹⁹ | 7.6 × 10⁻¹⁹ |
| α[dB/km] | 5 | 3 | 1 |

Based on the technique described in the non-patent literature (F. Cocchini, “The Lateral Rigidity of Double-Coated Optical Fibers”, JOURNAL OF LIGHTWAVE TECHNOLOGY, Vol. 13, No. 8, August 1995), two-dimensional finite element method (FEM) calculations were performed using the analysis software MSC. Nastran 2020 sp1 for 378 combinations where the cladding diameter (2R0) is 75 μm or more and 130 μm or less, the primary diameter (2R1) is 0 μm or more and 210 μm or less, the secondary diameter (2R2) is 110 μm or more and 210 μm less, Young's modulus of the primary resin layer E1 is 0.05 MPa or more and 0.7 MPa or less, and the Young's modulus of the secondary resin layer E2 is 1000 MPa or more and 3000 MPa or less.

Subsequently, the lateral rigidity D of each structure was calculated from the analysis results using the following formula.

$$D = 2 F θ R 2 / {uy}^{*}$$

In this formula, F is the lateral pressure (1 MPa), θ is the stress application angle (0 degrees or more and 9 degrees or less), and uy* is the displacement of the pressurized part in each structure.

Furthermore, from the results of the lateral rigidity D obtained for each structure, the following analytical formula was obtained with R0, R1, R2, E0, E1, and E2 as explanatory variables. Moreover, c1, c2, c3, and cᵢⱼₖ are as described above.

$${log}_{10} \frac{D - D 1}{D 2 - D 1} \sim {\sum }_{i , j , k} {c}_{ijk} {( {log}_{10} \frac{R 2 - R 1}{R 2 - R 0} )}^{i} {( {log}_{10} \frac{E 1}{E 2} )}^{j} {( {log}_{10} \frac{R 0}{R 2} )}^{k} \qquad ( 5 )$$

Where,

$$\frac{D 1}{E 1} = \frac{D 2}{E 2} = \frac{c 1}{{( 1 - \frac{R 0}{R 2} )}^{c 2}} + c 3 \qquad ( 6 )$$

By rearranging these Formulas (5) and (6), Formula (1) was obtained. By using Formula (1), the lateral rigidity D can be calculated, and D/H² in Formula (3) can be obtained.

In addition, in the optical fiber 1 according to the present embodiment, the relative ratio of D/H², which indicates the relationship between the lateral rigidity D and the bending rigidity H of the optical fiber 1, to D/H² of the 200 μm single fiber is adjusted to be 540 or less. The lateral rigidity D and the bending rigidity H referred to herein can be obtained from the above-mentioned Formulas (1) and (2). The calculation conditions for D/H² of the reference 200 μm single fiber are as follows.
The radius of the glass fiber is 62.5 μm.
The radius of the primary resin layer is 85 μm.
The radius of the secondary resin layer is 96.5 μm.
Young's modulus of the glass fiber is 72500 [MPa].
Young's modulus of the primary resin layer is 0.4 [MPa].
Young's modulus of the secondary resin layer is 1500 [MPa].

In this case, the bending rigidity H of the 200 μm single fiber is calculated to be 3.63808×10⁻¹², the lateral rigidity D [MPa] of the 200 μm single fiber is calculated to be 3.821657426, and D/H² is calculated to be 2.88739×10²³.

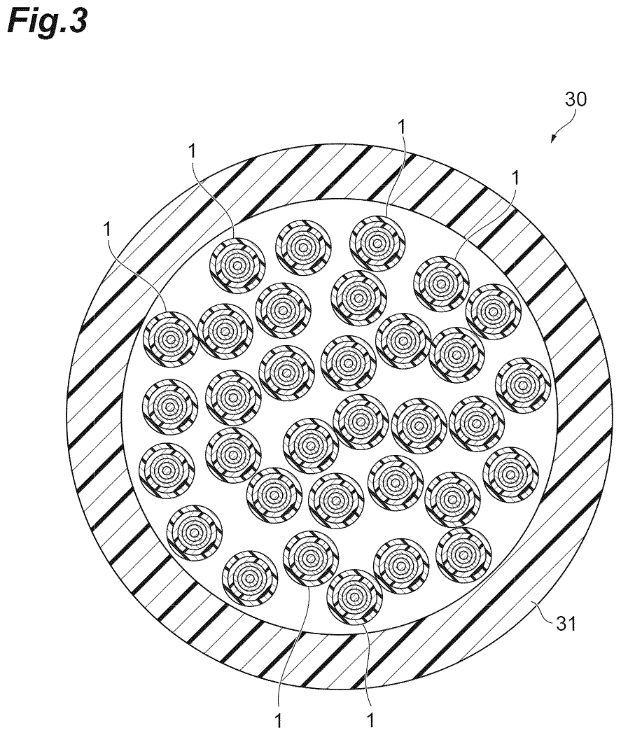

In addition, a plurality of optical fibers 1 with such a structure may be prepared to form an optical cable 30 as illustrated in FIG. 3. In the optical cable 30, a plurality of optical fibers 1 are housed in a cable sheath 31. As described above, although each optical fiber 1 is a small-diameter fiber, the micro-bending loss is reduced, leading to a reduction in the cable loss. In the optical cable 30, the fibers housed therein are small-diameter, so more optical fibers 1 can be housed in the cable sheath 31 compared to conventional cables, or alternatively, it is possible to reduce the outer diameter of the cable sheath 31.

An experimental example of the optical fiber according to the present embodiment is now described. In the following experimental examples, the optical fibers 1 with the structures indicated in Tables 2 to 6 were prototyped, and various indices were obtained from each of the optical fibers that were actually prototyped. These indices are indicated in Tables 7 to 11.

TABLE 2

| | | Experimental | Experimental | Experimental | Experimental | Experimental |
|---|---|---|---|---|---|---|
| Items | Units | Example 1 | Example 2 | Example 3 | Example 4 | Example 5 |
| Diameter of glass fiber | μm | 80 | 80.5 | 80 | 80 | 80.5 |
| Radius of core | μm | 4.5 | 4.29 | 4.5 | 4.47 | 3.98 |
| Relative refractive index of core | % | 0.34 | 0.38 | 0.38 | 0.38 | 0 |
| Relative refractive index | % | 0.34 | 0.38 | 0.36 | 0.38 | 0.39 |
| difference of core (relative to | | | | | | |
| inner cladding) | | | | | | |
| Radius of inner cladding | μm | 10.2 | 10.54 | 10.2 | 11.02 | 10.47 |
| Relative refractive index | % | 0 | 0 | 0.02 | 0 | −0.39 |
| difference of inner cladding | | | | | | |
| Radius of trench | μm | 17.5 | 17.83 | 17.5 | 15.13 | 15.88 |
| Relative refractive index | % | −0.27 | −0.29 | −0.26 | −0.39 | −0.81 |
| difference of trench | | | | | | |
| Volume of trench | % · μm² | −171.5 | −187.8 | −165.2 | −130.0 | −363.20 |
| Radius of outer cladding | μm | 40 | 40.25 | 40 | 40 | 40.25 |
| Relative refractive index | % | 0 | 0 | 0 | 0 | −0.394 |
| difference of outer cladding | | | | | | |
| Diameter of coating layer | μm | 165 | 165.5 | 165 | 165 | 165.5 |
| Diameter of primary resin layer | μm | 120 | 120.5 | 110 | 130 | 130.5 |
| Thickness of primary resin layer | μm | 20 | 20 | 15 | 25 | 25 |
| Young's modulus of primary resin | MPa | 0.26 | 0.2 | 0.3 | 0.2 | 0.2 |
| layer | | | | | | |
| Diameter of secondary resin layer | μm | 165 | 157.5 | 155 | 155 | 165.5 |
| Thickness of secondary resin | μm | 22.5 | 18.5 | 22.5 | 12.5 | 17.5 |
| layer | | | | | | |
| Young's modulus of secondary | MPa | 1400 | 1800 | 1600 | 1500 | 1250 |
| resin layer | | | | | | |
| Thickness of third layer | μm | 0 | 4 | 5 | 5 | 0 |
| Total thickness of secondary resin | μm | 22.5 | 22.5 | 27.5 | 17.5 | 17.5 |
| layer and third layer | | | | | | |
| Primary thickness/(total thickness | Ratio | 0.89 | 0.89 | 0.55 | 1.43 | 1.43 |
| of secondary and third layers) | | | | | | |
| Total cross-sectional area of | μm² | 10073 | 10108 | 11879 | 8109 | 8137 |
| secondary resin layer and third | | | | | | |
| layer | | | | | | |

TABLE 3

| | | Experimental | Experimental | Experimental | Experimental | Experimental |
|---|---|---|---|---|---|---|
| Items | Units | Example 6 | Example 7 | Example 8 | Example 9 | Example 10 |
| Diameter of glass fiber | μm | 62.5 | 63 | 62.5 | 62.5 | 63 |
| Radius of core | μm | 4.37 | 4.8 | 5 | 4.0 | 4.33 |
| Relative refractive index of core | % | 0.39 | 0.34 | 0.33 | 0 | 0.40 |
| Relative refractive index | % | 0.39 | 0.34 | 0.32 | 0.32 | 0.40 |
| difference of core (relative to | | | | | | |
| inner cladding) | | | | | | |
| Radius of inner cladding | μm | 10.19 | 10 | 10 | 10 | 9.04 |
| Relative refractive index | % | 0 | 0 | 0.01 | −0.32 | 0 |
| difference of inner cladding | | | | | | |
| Radius of trench | μm | 16.28 | 18.2 | 18.5 | 18 | 14.71 |
| Relative refractive index | % | −0.42 | −0.21 | −0.19 | −0.54 | −0.44 |
| difference of trench | | | | | | |
| Volume of trench | % · μm² | −211.2 | −152.6 | −144.6 | −380.0 | −187.4 |
| Radius of outer cladding | μm | 31.25 | 31.5 | 31.25 | 31.25 | 31.5 |
| Relative refractive index | % | 0 | 0 | 0 | −0.33 | 0 |
| difference of outer cladding | | | | | | |
| Diameter of coating layer | μm | 135 | 130 | 120 | 135 | 120 |
| Diameter of primary resin layer | μm | 98.5 | 103 | 92.5 | 102 | 89 |
| Thickness of primary resin layer | μm | 18 | 20 | 15 | 19.75 | 1.3 |
| Young's modulus of primary resin | MPa | 0.26 | 0.3 | 0.2 | 0.2 | 0.2 |
| layer | | | | | | |
| Diameter of secondary resin layer | μm | 135 | 130 | 112 | 127 | 112 |
| Thickness of secondary resin | μm | 18.25 | 13.5 | 9.75 | 12.5 | 11.5 |
| layer | | | | | | |
| Young's modulus of secondary | MPa | 1800 | 1300 | 1600 | 2000 | 1900 |
| resin layer | | | | | | |
| Thickness of third layer | μm | 0 | 0 | 4 | 4 | 4 |
| Total thickness of secondary resin | μm | 18.25 | 13.5 | 13.75 | 16.5 | 15.5 |
| layer and third layer | | | | | | |
| Primary thickness/(total thickness | Ratio | 0.99 | 1.48 | 1.09 | 1.20 | 0.84 |
| of secondary and third layers) | | | | | | |
| Total cross-sectional area of | μm² | 6694 | 4941 | 4590 | 6143 | 5089 |
| secondary resin layer and third | | | | | | |
| layer | | | | | | |

TABLE 4

| | | Experimental | Experimental | Experimental | Experimental | Experimental |
|---|---|---|---|---|---|---|
| Items | Units | Example 11 | Example 12 | Example 13 | Example 14 | Example 15 |
| Diameter of glass fiber | μm | 50 | 50.5 | 50 | 50 | 50.5 |
| Radius of core | μm | 5 | 5 | 4.5 | 4.38 | 4.5 |
| Relative refractive index of core | % | 0.33 | 0.33 | 0.34 | 0.40 | 0.34 |
| Relative refractive index | % | 0.32 | 0.32 | 0.32 | 0.40 | 0.32 |
| difference of core (relative to | | | | | | |
| inner cladding) | | | | | | |
| Radius of inner cladding | μm | 10 | 10 | 10.2 | 9.38 | 10.2 |
| Relative refractive index | % | 0.01 | 0.01 | 0.02 | 0 | 0.02 |
| difference of inner cladding | | | | | | |
| Radius of trench | μm | 18.5 | 18.5 | 17.5 | 14.90 | 17.5 |
| Relative refractive index | % | −0.19 | −0.19 | −0.26 | −0.39 | −0.26 |
| difference of trench | | | | | | |
| Volume of trench | % · μm² | −144.6 | −144.6 | −165.2 | −165.9 | −165.2 |
| Radius of outer cladding | μm | 25 | 25.25 | 25 | 25 | 25.25 |
| Relative refractive index | % | 0 | 0 | 0 | 0 | 0 |
| difference of outer cladding | | | | | | |
| Diameter of coating layer | μm | 125 | 120 | 110 | 130 | 110 |
| Diameter of primary resin layer | μm | 90 | 90.5 | 80 | 95 | 75.5 |
| Thickness of primary resin layer | μm | 20 | 20 | 15 | 22.5 | 12.5 |
| Young's modulus of primary resin | MPa | 0.26 | 0.2 | 0.2 | 0.2 | 0.2 |
| layer | | | | | | |
| Diameter of secondary resin layer | μm | 125 | 120 | 102 | 122 | 102 |
| Thickness of secondary resin | μm | 17.5 | 14.75 | 11 | 13.5 | 13.25 |
| layer | | | | | | |
| Young's modulus of secondary | MPa | 1650 | 1500 | 1350 | 1500 | 1700 |
| resin layer | | | | | | |
| Thickness of third layer | μm | 0 | 0 | 4 | 4 | 4 |
| Total thickness of secondary resin | μm | 17.5 | 14.75 | 15 | 17.5 | 17.25 |
| layer and third layer | | | | | | |
| Primary thickness/(total thickness | Ratio | 1.14 | 1.36 | 1.00 | 1.29 | 0.72 |
| of secondary and third layers) | | | | | | |
| Total cross-sectional area of | μm² | 5910 | 4877 | 4477 | 6185 | 5026 |
| secondary resin layer and third | | | | | | |
| layer | | | | | | |

TABLE 5

| | | Experimental | Experimental | Experimental | Experimental | Experimental |
|---|---|---|---|---|---|---|
| Items | Units | Example 16 | Example 17 | Example 18 | Example 19 | Example 20 |
| Diameter of glass fiber | μm | 80.5 | 80.5 | 125 | 126 | 125 |
| Radius of core | μm | 4.37 | 4.51 | 4.51 | 4.57 | 4.6 |
| Relative refractive index of core | % | 0.37 | 0.37 | 0.35 | 0.32 | 0.3 |
| Relative refractive index | % | 0.37 | 0.37 | 0.35 | 0.32 | 0.35 |
| difference of core (relative to | | | | | | |
| inner cladding) | | | | | | |
| Radius of inner cladding | μm | 9.61 | 9.98 | 9.93 | 10.19 | 10 |
| Relative refractive index | % | 0 | 0 | 0 | 0 | −0.05 |
| difference of inner cladding | | | | | | |
| Radius of trench | μm | 14.28 | 15.27 | 14.59 | 14.62 | 18.3 |
| Relative refractive index | % | −0.38 | −0.33 | −0.36 | −0.37 | −0.26 |
| difference of trench | | | | | | |
| Volume of trench | % · μm² | −131.4 | −139.7 | −129.2 | −126.0 | −191.9 |
| Radius of outer cladding | μm | 40.25 | 40.25 | 62.5 | 63 | 62.5 |
| Relative refractive index | % | 0 | 0 | 0 | 0 | 0 |
| difference of outer cladding | | | | | | |
| Diameter of coating layer | μm | 129 | 131 | 165 | 165 | 165 |
| Diameter of primary resin layer | μm | 97.5 | 100 | 140 | 140 | 140 |
| Thickness of primary resin layer | μm | 8.5 | 9.75 | 7.5 | 7 | 7.5 |
| Young's modulus of primary resin | MPa | 0.2 | 0.2 | 0.12 | 0.3 | 0.12 |
| layer | | | | | | |
| Diameter of secondary resin layer | μm | 125 | 125 | 155 | 155 | 155 |
| Thickness of secondary resin | μm | 13 | 12.5 | 7.5 | 7.5 | 7.5 |
| layer | | | | | | |
| Young's modulus of secondary | MPa | 1600 | 1600 | 2000 | 2000 | 2000 |
| resin layer | | | | | | |
| Thickness of third layer | μm | 2 | 3 | 5 | 5 | 5 |
| Total thickness of secondary resin | μm | 1.5 | 15.5 | 12.5 | 12.5 | 12.5 |
| layer and third layer | | | | | | |
| Primary thickness/(total thickness | Ratio | 0.57 | 0.63 | 0.60 | 0.56 | 0.60 |
| of secondary and third layers) | | | | | | |
| Total cross-sectional area of | μm² | 5604 | 5624 | 5989 | 5989 | 5989 |
| secondary resin layer and third | | | | | | |
| layer | | | | | | |

TABLE 6

| | | Experimental | Experimental | Experimental | Experimental | Experimental |
|---|---|---|---|---|---|---|
| Items | Units | Example 21 | Example 22 | Example 23 | Example 24 | Example 25 |
| Diameter of glass fiber | μm | 126 | 100 | 100 | 50 | 80 |
| Radius of core | μm | 4.37 | 4.5 | 5 | 4.51 | 4.57 |
| Relative refractive index of core | % | 0.39 | 0.34 | 0.33 | 0.35 | 0.32 |
| Relative refractive index | % | 0.39 | 0.32 | 0.32 | 0.35 | 0.32 |
| difference of core (relative to | | | | | | |
| inner cladding) | | | | | | |
| Radius of inner cladding | μm | 10.19 | 10.2 | 10 | 9.93 | 10.19 |
| Relative refractive index | % | 0 | 0.02 | 0.01 | 0 | 0 |
| difference of inner cladding | | | | | | |
| Radius of trench | μm | 16.28 | 17.5 | 18.5 | 14.59 | 14.62 |
| Relative refractive index | % | −0.42 | −0.26 | −0.19 | −0.36 | −0.37 |
| difference of trench | | | | | | |
| Volume of trench | % · μm² | −211.2 | −165.2 | −144.6 | −129.2 | −126.0 |
| Radius of outer cladding | μm | 63 | 50 | 50 | 25 | 25 |
| Relative refractive index | % | 0 | 0 | 0 | 0 | 0 |
| difference of outer cladding | | | | | | |
| Diameter of coating layer | μm | 165 | 165 | 165 | 80 | 100 |
| Diameter of primary resin layer | μm | 134 | 120 | 130 | 58 | 87 |
| Thickness of primary resin layer | μm | 4 | 10 | 15 | 4 | 3.5 |
| Young's modulus of primary resin | MPa | 0.3 | 0.12 | 0.2 | 0.3 | 0.3 |
| layer | | | | | | |
| Diameter of secondary resin layer | μm | 155 | 155 | 155 | 70 | 93 |
| Thickness of secondary resin | μm | 10.5 | 17.5 | 12.5 | 6 | 3 |
| layer | | | | | | |
| Young's modulus of secondary | MPa | 2000 | 2000 | 2000 | 1200 | 1200 |
| resin layer | | | | | | |
| Thickness of third layer | μm | 5 | 5 | 5 | 5 | 5 |
| Total thickness of secondary resin | μm | 15.5 | 22.5 | 17.5 | 11 | 8 |
| layer and third layer | | | | | | |
| Primary thickness/(total thickness | Ratio | 0.26 | 0.44 | 0.86 | 0.36 | 0.44 |
| of secondary and third layers) | | | | | | |
| Total cross-sectional area of | μm² | 7280 | 10073 | 8109 | 2384 | 1909 |
| secondary resin layer and third | | | | | | |
| layer | | | | | | |

TABLE 7

| | | Experimental | Experimental | Experimental | Experimental | Experimental |
|---|---|---|---|---|---|---|
| Items | Units | Example 1 | Example 2 | Example 3 | Example 4 | Example 5 |
| Effective cross-sectional area Aeff | μm² | 81.18 | 74.82 | 87.12 | 75.59 | 71.81 |
| MFD (wavelength 1310 nm) | μm | 9.22 | 8.63 | 9.39 | 8.83 | 8.52 |
| MFD (wavelength 1550 nm) | μm | 10.27 | 9.76 | 10.48 | 9.91 | 9.61 |
| MFD (wavelength 1625 nm) | μm | 10.61 | 10.07 | 10.83 | 10.28 | 9.95 |
| Dispersion (wavelength 1310 nm) | | −0.79 | −0.47 | −0.88 | 0.46 | −0.18 |
| Dispersion slope (wavelength 1310 nm) | | 0.089 | 0.088 | 0.090 | 0.089 | 0.088 |
| Zero-dispersion wavelength (λ0) | nm | 1319 | 1315 | 1320 | 1305 | 1312 |
| Cable cutoff wavelength (λcc) | nm | 1315 | 1199 | 1339 | 1259 | 1218 |
| MAC value | | 7.01 | 7.18 | 7.01 | 7.01 | 7.00 |
| Bending loss (φ10, wavelength 1550 nm) | dB/turn | 0.25 | 0.078 | 0.15 | 0.2 | 0.082 |
| Bending loss (φ15, wavelength 1550 nm) | dB/turn | 0.04 | 0.057 | 0.042 | 0.046 | 0.06 |
| Bending loss (φ20, wavelength 1550 nm) | dB/turn | 0.009 | 0.008 | 0.009 | 0.006 | 0.008 |
| Bending loss (φ30, wavelength 1550 nm) | dB/turn | 0.001 | 0.0003 | 0.001 | 0.001 | 0.0005 |
| Bending loss (φ10, wavelength 1625 nm) | dB/turn | 0.78 | 0.24 | 0.44 | 0.72 | 0.27 |
| Attenuation (wavelength 1310 nm) | dB/km | * | * | * | * | * |
| Attenuation (wavelength 1550 nm) | dB/km | * | * | * | * | * |
| Attenuation (wavelength 1625 nm) | dB/km | * | * | * | * | * |

TABLE 8

| | | Experimental | Experimental | Experimental | Experimental | Experimental |
|---|---|---|---|---|---|---|
| Items | Units | Example 6 | Example 7 | Example 8 | Example 9 | Example 10 |
| Effective cross-sectional area Aeff | μm² | 72.41 | 78.85 | 78 | 85.72 | 71.24 |
| MED (wavelength 1310 nm) | μm | 8.59 | 8.95 | 8.95 | 9.40 | 8.45 |
| MFD (wavelength 1550 nm) | μm | 9.65 | 10.02 | 10.02 | 10.5 | 9.43 |
| MFD (wavelength 1625 nm) | μm | 9.95 | 10.41 | 10.32 | 10.81 | 9.76 |
| Dispersion (wavelength 1310 nm) | | 0.22 | −0.43 | −0.79 | −1.06 | 0.56 |
| Dispersion slope (wavelength 1310 nm) | | 0.089 | 0.09 | 0.091 | 0.890 | 0.09 |
| Zero-dispersion wavelength (λ0) | nm | 1307 | 1315 | 1319 | 1322 | 1304 |
| Cable cutoff wavelength (λcc) | nm | 1239 | 1296 | 1394 | 1308 | 1217 |
| MAC value | | 6.93 | 6.9 | 6.42 | 7.19 | 6.94 |
| Bending loss (φ10, wavelength 1550 nm) | dB/turn | 0.03 | 0.1 | 0.015 | 0.674 | 0.049 |
| Bending loss (φ15, wavelength 1550 nm) | dB/turn | 0.025 | 0.066 | 0.008 | 0.071 | 0.043 |
| Bending loss (φ20, wavelength 1550 nm) | dB/turn | 0.007 | 0.004 | 0.002 | 0.006 | 0.006 |
| Bending loss (φ30, wavelength 1550 nm) | dB/turn | 0.0008 | 0.001 | 0.0005 | 0.002 | 0.0002 |
| Bending loss (φ10, wavelength 1625 nm) | dB/turn | 0.07 | 3.30 | 0.05 | 2.29 | 0.17 |
| Attenuation (wavelength 1310 nm) | dB/km | * | 0.309 | * | 0.33 | * |
| Attenuation (wavelength 1550 nm) | dB/km | * | 0.175 | 0.175 | 0.179 | * |
| Attenuation (wavelength 1625 nm) | dB/km | * | * | * | 0.192 | * |

TABLE 9

| | | Experimental | Experimental | Experimental | Experimental | Experimental |
|---|---|---|---|---|---|---|
| Items | Units | Example 11 | Example 12 | Example 13 | Example 14 | Example 15 |
| Effective cross-sectional area Aeff | μm² | 78 | 78 | 81.40 | 71.44 | 81.40 |
| MFD (wavelength 1310 nm) | μm | 8.95 | 8.95 | 9.07 | 8.50 | 9.07 |
| MED (wavelength 1550 nm) | μm | 10.02 | 10.02 | 10.08 | 9.49 | 10.08 |
| MFD (wavelength 1625 nm) | μm | 10.32 | 10.32 | 10.41 | 9.80 | 10.41 |
| Dispersion (wavelength 1310 nm) | | −0.79 | −0.79 | −0.79 | 0.51 | −0.79 |
| Dispersion slope (wavelength 1310 nm) | | 0.091 | 0.091 | 0.091 | 0.090 | 0.091 |
| Zero-dispersion wavelength (λ0) | nm | 1319 | 1319 | 1319 | 1304 | 1319 |
| Cable cutoff wavelength (λcc) | nm | 1394 | 1394 | 1419 | 1238 | 1419 |
| MAC value | | 6.42 | 6.42 | 6.39 | 6.87 | 6.39 |
| Bending loss (φ10, wavelength 1550 nm) | dB/turn | 0.015 | 0.015 | 0.02 | 0.072 | 0.02 |
| Bending loss (φ15, wavelength 1550 nm) | dB/turn | 0.008 | 0.008 | 0.0137 | 0.055 | 0.0137 |
| Bending loss (φ20, wavelength 1550 nm) | dB/turn | 0.002 | 0.002 | 0.003 | 0.005 | 0.003 |
| Bending loss (φ30, wavelength 1550 nm) | dB/turn | 0.0005 | 0.0005 | 0.0002 | 0.0001 | 0.0002 |
| Bending loss (φ10, wavelength 1625 nm) | dB/turn | 0.05 | 0.05 | 0.06 | 0.29 | 0.06 |
| Attenuation (wavelength 1310 nm) | dB/km | * | * | * | * | * |
| Attenuation (wavelength 1550 nm) | dB/km | 0.175 | 0.175 | * | * | * |
| Attenuation (wavelength 1625 nm) | dB/km | * | * | * | * | * |

TABLE 10

| | | Experimental | Experimental | Experimental | Experimental | Experimental |
|---|---|---|---|---|---|---|
| Items | Units | Example 16 | Example 17 | Example 18 | Example 19 | Example 20 |
| Effective cross-sectional area Aeff | μm² | 74.22 | 78.68 | 79.33 | 82.33 | 82.97 |
| MFD (wavelength 1310 nm) | μm | 8.71 | 8.84 | 8.96 | 9.17 | 9.24 |
| MFD (wavelength 1550 nm) | μm | 9.77 | 9.91 | 10.05 | 10.29 | 10.33 |
| MFD (wavelength 1625 nm) | μm | 10.12 | 10.25 | 10.39 | 10.67 | 10.65 |
| Dispersion (wavelength 1310 nm) | | 0.28 | 0.46 | 0.47 | 0.59 | −1.15 |
| Dispersion slope (wavelength 1310 nm) | | 0.090 | 0.089 | 0.090 | 0.090 | 0.890 |
| Zero-dispersion wavelength (λ0) | nm | 1307 | 1305 | 1305 | 1303 | 1323 |
| Cable cutoff wavelength (λcc) | nm | 1192 | 1220 | 1389 | 1179 | 1183 |
| MAC value | | 7.31 | 7.25 | 7.54 | 7.78 | 7.81 |
| Bending loss (φ10, wavelength 1550 nm) | dB/turn | 0.32 | 0.234 | 0.446 | 0.672 | 0.79 |
| Bending loss (φ15, wavelength 1550 nm) | dB/turn | 0.05 | 0.07 | 0.075 | 0.082 | 0.047 |
| Bending loss (φ20, wavelength 1550 nm) | dB/turn | 0.0085 | 0.005 | 0.013 | 0.018 | 0.01 |
| Bending loss (φ30, wavelength 1550 nm) | dB/turn | 0.002 | 0.002 | 0.002 | 0.001 | 0.003 |
| Bending loss (φ10, wavelength 1625 nm) | dB/turn | 0.77 | 0.75 | 1.32 | 2.28 | 2.39 |
| Attenuation (wavelength 1310 nm) | dB/km | * | * | * | * | 0.33 |
| Attenuation (wavelength 1550 nm) | dB/km | * | * | * | * | 0.196 |
| Attenuation (wavelength 1625 nm) | dB/km | * | * | * | * | * |

TABLE 11

| | | Experimental | Experimental | Experimental | Experimental | Experimental |
|---|---|---|---|---|---|---|
| Items | Units | Example 21 | Example 22 | Example 23 | Example 24 | Example 25 |
| Effective cross-sectional area Aeff | μm² | 72.41 | 81.40 | 78 | 79.33 | 82.33 |
| MFD (wavelength 1310 nm) | μm | 8.59 | 9.07 | 8.95 | 8.96 | 9.17 |
| MED (wavelength 1550 nm) | μm | 9.65 | 10.08 | 10.02 | 10.05 | 10.29 |
| MFD (wavelength 1625 nm) | μm | 9.95 | 10.41 | 10.32 | 10.39 | 10.67 |
| Dispersion (wavelength 1310 nm) | | 0.22 | −0.79 | −0.79 | 0.47 | 0.59 |
| Dispersion slope (wavelength 1310 nm) | | 0.089 | 0.091 | 0.091 | 0.090 | 0.090 |
| Zero-dispersion wavelength (λ0) | nm | 1307 | 1319 | 1319 | 1305 | 1303 |
| Cable cutoff wavelength (λcc) | nm | 1239 | 1419 | 1394 | 1189 | 1179 |
| MAC value | | 6.93 | 6.39 | 6.42 | 7.54 | 7.78 |
| Bending loss (φ10, wavelength 1550 nm) | dB/turn | 0.03 | 0.02 | 0.015 | 0.446 | 0.672 |
| Bending loss (φ15, wavelength 1550 nm) | dB/turn | 0.025 | 0.0137 | 0.008 | 0.075 | 0.082 |
| Bending loss (φ20, wavelength 1550 nm) | dB/turn | 0.007 | 0.003 | 0.002 | 0.013 | 0.018 |
| Bending loss (φ30, wavelength 1550 nm) | dB/turn | 0.0008 | 0.0002 | 0.0005 | 0.002 | 0.001 |
| Bending loss (φ10, wavelength 1625 nm) | dB/turn | 0.07 | 0.06 | 0.05 | 1.32 | 2.28 |
| Attenuation (wavelength 1310 nm) | dB/km | * | * | * | * | * |
| Attenuation (wavelength 1550 nm) | dB/km | * | * | 0.175 | * | * |
| Attenuation (wavelength 1625 nm) | dB/km | * | * | * | * | * |

The relative lateral pressure sensitivity coefficient (the ratio of D/H² to that of a 200 μm single fiber) in the above-mentioned Experimental Examples 1 to 25 was as indicated in Table 12 below. In other words, for Experimental Examples 1 to 23 and 25, the relative lateral pressure sensitivity coefficient was 540 or less. On the other hand, in Experimental Example 24, the relative lateral pressure sensitivity coefficient was a value exceeding 3000, resulting in a significantly large value. This means that the micro-bending loss and cable loss became large, making it difficult to meet, for example, the standard cable loss (less than 0.3 dB/km). In Table 12, evaluation A in the cable loss of Table 12 indicates that the standard cable loss (less than 0.3 dB/km) is satisfied, while evaluation B indicates that the standard cable loss (less than 0.3 dB/km) is not satisfied.

TABLE 12

| | Relative value of lateral pressure | | Tensile test | |
|---|---|---|---|---|
| | sensitivity coefficient D/H² | Cable loss | (median breaking stress [GPa]) | |
| | (ration to 200 μm single fiber) | (standard < 0.3 dB/km) | (standard ≥ 1.5 GPa) | |
| Experimental Example 1 | 21.7 | A | A | 3.9 |
| Experimental Example 2 | 14.7 | A | A | 4.8 |
| Experimental Example 3 | 28.7 | A | A | 4.3 |
| Experimental Example 4 | 13.6 | A | A | 4.3 |
| Experimental Example 5 | 13.8 | A | A | 4.0 |
| Experimental Example 6 | 110.9 | A | A | 3.8 |
| Experimental Example 7 | 136.1 | A | A | 3.8 |
| Experimental Example 8 | 137.3 | A | A | 3.2 |
| Experimental Example 9 | 76.5 | A | A | 3.8 |
| Experimental Example 10 | 141.6 | A | A | 3.1 |
| Experimental Example 11 | 300.6 | A | A | 3.5 |
| Experimental Example 12 | 295.9 | A | A | 3.4 |
| Experimental Example 13 | 539.9 | A | A | 4.5 |
| Experimental Example 14 | 189.6 | A | A | 2.0 |
| Experimental Example 15 | 519.2 | A | A | 1.5 |
| Experimental Example 16 | 40.4 | A | A | 3.9 |
| Experimental Example 17 | 36.3 | A | A | 4.2 |
| Experimental Example 18 | 1.0 | A | A | 3.3 |
| Experimental Example 19 | 2.2 | A | A | 3.5 |
| Experimental Example 20 | 1.0 | A | A | 3.4 |
| Experimental Example 21 | 3.2 | A | A | 3.3 |
| Experimental Example 22 | 4.4 | A | A | 3.7 |
| Experimental Example 23 | 5.2 | A | A | 3.5 |
| Experimental Example 24 | 3147.9 | B | B | 1.0 |
| Experimental Example 25 | 83.9 | A | B | 0.4 |

Table 12 also indicates the results of the tensile test for the optical fiber 1. In this test, a tensile tester having a first mandrel and a second mandrel was prepared, and sandpaper with an average particle size of 15 μm or more and 25 μm or less was wrapped around the first mandrel. The first mandrel and the second mandrel were arranged to be spaced apart from each other by a predetermined distance. Then, both ends of the optical fiber 1 were wound around the first mandrel and the second mandrel to perform the tensile test. The first mandrel has one end of the optical fiber 1 wrapped on the sandpaper described above. In this test, the median breaking stress of the optical fibers of the above-mentioned Experimental Example 1 to Experimental Example 25 was measured. As indicated in Table 12, it was confirmed that the median breaking stress was 1.5 GPa or more, which is the standard value, in Experimental Example 1 to Experimental Example 23. On the other hand, in Experimental Examples 24 and 25, the median breaking stress was smaller than the standard value of 1.5 GPa. This is considered to be due to the fact that in Experimental Examples 24 and 25, in addition to the fact that the fibers are small in diameter, the thickness of the primary resin layer is 4 μm or less, and the thickness of the secondary resin layer is 6 μm or less. Thus, with the optical fibers according to Experimental Examples 1 to 23, it is possible to reduce the diameter of the optical fiber, reduce micro-bending loss, and still maintain the required tensile strength.

As described above, the optical fiber 1 satisfies at least the following requirements.
The core has a radius of 3.6 μm or more and 5.4 μm or less, and the relative refractive index difference of the core with respect to the refractive index of the cladding is greater than the refractive index of the cladding by 0.32% or more and 0.40% or less.
The volume of the trench is less than −30% μm²
The radius of the cladding is 63 μm or less.
The thickness of the primary resin layer is 4 μm or more, and Young's modulus of the primary resin layer is 0.3 MPa or less.
The radius of the secondary resin layer is 85 μm or less, the thickness of the secondary resin layer is 7.5 μm or more, and Young's modulus of the secondary resin layer is 1250 MPa or more.
The effective cross-sectional area of the optical fiber at a wavelength of 1550 nm is 100 μm² or less.
The mode field diameter of the optical fiber at a wavelength of 1310 nm is greater than 8.2 μm.
The mode field diameter of the optical fiber at a wavelength of 1550 nm is 9.40 μm or more and 10.5 μm or less.
The cable cutoff wavelength of the optical fiber is less than 1420 nm.
The bending loss of the optical fiber at a wavelength of 1550 nm upon being wound with a bending diameter of 10 mm is 1 dB/turn or less.
The relative ratio of D/H², which indicates the relationship between a lateral rigidity D and a bending rigidity H of the optical fiber, to D/H² of a reference 200 μm single fiber is 540 or less.
The cross-sectional area of the coating layer that excludes the primary resin layer is 4400 μm² or more and 12000 μm² or less.
The absolute difference between the refractive index of the cladding and the refractive index of the coating layer is greater than 0.01.
The optical fiber has a zero-dispersion slope of 0.092 ps/nm²/km or less.

As described above, in the optical fiber 1, it is possible to reduce micro-bending loss in a small-diameter optical fiber. This allows for a reduction in cable loss when the optical fiber is incorporated into a cable.

Furthermore, in the optical fiber 1, the lateral rigidity D and the bending rigidity H satisfy Formula (3), so micro-bending loss can be reliably suppressed. As the coating eccentricity increases, the discrepancy between the calculated and actual measured values of micro-bending loss becomes larger. In the optical fiber 1, the coating eccentricity is 8 μm or less, so the discrepancy between the calculated and actual measured values of micro-bending loss is suppressed. Thus, the micro-bending loss can be more reliably suppressed. In the case where the coating eccentricity was 5 μm, the relative error between the calculated value and the actual measured value was 5.3%. In the case where the coating eccentricity was 8 μm, the relative error between the calculated value and the actual measured value was 9.8%. In the case where the coating eccentricity was 10 μm, the relative error between the calculated value and the actual measured value was 21.8%. A relative error of 10% or less is desirable, so a coating eccentricity of 8 μm or less is preferable. In order to further reduce the relative error, a lower coating eccentricity is better.

Although the embodiments of the present disclosure have been described above, the present disclosure is not necessarily limited to the above-described embodiments, and various modifications are possible without departing from the spirit of the present disclosure.

What is claimed is:

1. An optical fiber comprising:
a glass fiber including a core and a cladding surrounding the core; and
a coating layer surrounding the glass fiber, wherein
the core is formed from silica glass doped with at least one of germanium, titanium, chlorine, fluorine, and alkali metals,
the cladding includes an inner cladding in contact with and surrounding the core, an outer cladding surrounding the inner cladding, and a trench placed between the inner cladding and the outer cladding in a radial direction,
the coating layer includes a primary resin layer surrounding the cladding and a secondary resin layer surrounding the primary resin layer,
the core has a radius of 3.6 μm or more and 5.4 μm or less and has a relative refractive index difference with respect to a refractive index of the cladding being greater than the refractive index of the cladding by 0.32% or more and 0.40% or less,
the trench has a volume being smaller than −30%·μm²,
the cladding has a radius of 63 μm or less,
the primary resin layer has a thickness of 4 μm or more and Young's modulus of 0.3 MPa or less,
the secondary resin layer has a radius of 85 μm or less, a thickness of 7.5 μm or more, and Young's modulus of 1250 MPa or more,
the optical fiber has an effective cross-sectional area of 100 μm² or less at a wavelength of 1550 nm,
the optical fiber has a mode field diameter being greater than 8.2 μm at a wavelength of 1310 nm,
the optical fiber has a mode field diameter of 9.40 μm or more and 10.5 μm or less at a wavelength of 1550 nm,
the optical fiber has a cable cutoff wavelength being less than 1420 nm,
the optical fiber has a bending loss of 1 dB/turn or less at a wavelength of 1550 nm upon being wound with a bending diameter of 10 mm,
the optical fiber has a relative ratio of D/H², which indicates a relationship between a lateral rigidity D and a bending rigidity H of the optical fiber, to D/H² of a reference 200 μm single fiber, of 540 or less,
the coating layer has a cross-sectional area of a portion of the coating layer excluding the primary resin layer of 4400 μm² or more and 12000 μm² or less,
the refractive index of the cladding and a refractive index of the coating layer have an absolute difference being greater than 0.01, and
the optical fiber has a zero-dispersion slope of 0.092 ps/nm²/km or less.

2. The optical fiber according to claim 1, wherein
the volume of the trench is −380%·μm² or more and −126%·μm² or less.

3. The optical fiber according to claim 1, wherein
given that the radius of the glass fiber is R0 [m], Young's modulus of the glass fiber is E0 [N/m²], the radius of the primary resin layer is R1 [m], Young's modulus of the primary resin layer is E1 [N/m²], the radius of the secondary resin layer is R2 [m], and Young's modulus of the secondary resin layer is E2 [N/m²], then, a relationship between a lateral rigidity D [N/m²] indicated in Formula (1) and a bending rigidity H [N/m²] indicated in Formula (2) of the optical fiber satisfies Formula (3), and a coating eccentricity is 8 μm or less,
$$D = \{ \frac{c 1}{{( 1 - \frac{R 0}{R 2} )}^{c 2}} + c 3 \} \{ ( E 2 - E 1 ) {10}^{{\sum }_{i , j , k} {{c}_{ijk} ( {log}_{10} \frac{R 2 - R 1}{R 2 - R 0} )}^{i} {( {log}_{10} \frac{E 1}{E 2} )}^{j} {( {log}_{10} \frac{R 0}{R 2} )}^{k}} + E 1 \} \qquad ( 1 )$$
$$H ∝ π R {0}^{4} E 0 + π ( R {2}^{4} - R {1}^{4} ) E 2 \qquad ( 2 )$$
$$D / {H}^{2} [ {N}^{- 1} \cdot {m}^{- 6} ] ≦ 6.6 \times {10}^{18} [ {N}^{- 1} \cdot {m}^{- 6} ] \qquad ( 3 )$$
where, c1=0.209367, c2=1.206659, and c3=0.401169, and cᵢⱼₖ is as follows:
$$\begin{matrix}{c}_{000} = - 0.611554 \\ {c}_{100} = 3.615414 \\ {c}_{010} = 0.253128 \\ {c}_{001} = - 7.130445 \\ {c}_{200} = 0.787599 \\ {c}_{110} = 0.329243 \\ {c}_{101} = 2.32008 \\ {c}_{020} = - 0.062024 \\ {c}_{011} = - 0.985974 \\ {c}_{002} = - 8.696048 .\end{matrix}$$

4. The optical fiber according to claim 1, wherein
the coating layer further includes a colored layer surrounding the secondary resin layer, and
the coating layer has a cross-sectional area of a portion of the coating layer constituted of the secondary resin layer and the colored layer being 4400 μm² or more and 12000 μm² or less.

5. The optical fiber according to claim 1, wherein
the radius of the secondary resin layer is 81 μm or less.

6. The optical fiber according to claim 1, wherein
the radius of the secondary resin layer is 51 μm or less.

7. The optical fiber according to claim 1, wherein
the optical fiber has a median breaking stress of 1.5 GPa or more when a tensile test is performed in a tensile tester having a first mandrel and a second mandrel with sandpaper having an average particle size of 15 μm or more and 25 μm or less wrapped around the first mandrel.

8. The optical fiber according to claim 1, wherein
the bending loss of the optical fiber at a wavelength of 1625 nm upon being wound with the bending diameter of 10 mm is 3 dB/turn or less.

9. An optical cable comprising a plurality of the optical fibers according to claim 1.
